(19) United States
(12) Patent Application Publication
(10) Pub. No.: US 2025/0114846 A1
(43) Pub. Date: Apr. 10, 2025

(54) FIXING MEMBER AND CUTTING TOOL

(71) Applicant: TUNGALOY CORPORATION, Iwaki-shi (JP)

(72) Inventor: Takehiro IDA, Iwaki-shi (JP)

(73) Assignee: TUNGALOY CORPORATION, Iwaki-shi (JP)

(21) Appl. No.: 18/907,269

(22) Filed: Oct. 4, 2024

(30) Foreign Application Priority Data
Oct. 6, 2023 (JP) 2023-174528

(51) Int. Cl. B23B 27/16

(52) U.S. Cl. CPC B23B 27/1662

(57) ABSTRACT

Provided are a fixing member and a cutting tool capable of pressing and fixing a cutting insert to a tool body in a stable state without defects such as wear and deformation.

A fixing member pressing and fixing a cutting insert disposed on an insert mounting part of a tool body includes a fixing member body configured to be fastened to a fixing member mounting part of the tool body and a pressing portion that is provided to the fixing member body and configured to press the cutting insert when the fixing member body is fastened to the tool body, wherein in the pressing portion, a bulging portion having an outer shape, in which a cross-sectional view in a direction orthogonal to a width direction of the fixing member body is curved in an arc shape, is formed along the width direction of the fixing member body.

### BACKGROUND

### Field

The present invention relates to a fixing member and a cutting tool.

### Description of Related Art

WO 2018/034339 discloses a cutting tool including a tool body, a cutting insert disposed on a mounting part of the tool body, and a fixing member that is fastened to the tool body to press and fix the cutting insert.

JP-A-2009-142943 discloses that, in the fixing member, two hemispherical protrusions are provided at a section that presses the cutting insert and discloses that these hemispherical protrusions are brought into contact with the cutting insert.

### SUMMARY

In the cutting tool described in WO 2018/034339, since, in the fixing member, the section that presses the cutting insert is a flat surface, the position of contact with the cutting insert is not stable, and there is a concern that the fixed state of the cutting insert becomes unstable when inclination occurs in the fixing member.

On the other hand, in the cutting tool described in JP-A-2009-142943, since the two hemispherical protrusions are brought into contact with the cutting insert, the cutting insert can be stably pressed. However, since the hemispherical protrusions come into point-contact with the cutting insert, there is a concern that a load concentrates and defects such as wear and deformation occur.

The present invention has been made in view of the above problems and has an object to provide a fixing member and a cutting tool capable of pressing and fixing a cutting insert to a tool body in a stable state without defects such as wear and deformation.

A fixing member according to one aspect of the present invention is a fixing member pressing and fixing a cutting insert disposed on an insert mounting part of a tool body, the fixing member including a fixing member body configured to be fastened to a fixing member mounting part of the tool body and a pressing portion that is provided to the fixing member body and configured to press the cutting insert when the fixing member body is fastened to the tool body, wherein in the pressing portion, a bulging portion having an outer shape, in which a cross-sectional view in a direction orthogonal to a width direction of the fixing member body is curved in an arc shape, is formed along the width direction of the fixing member body.

In the fixing member having the above configuration, the cutting insert is pressed and fixed by the bulging portion having an outer shape curved in an arc shape in a cross-sectional view and formed along the width direction of the fixing member body by being fastened to the tool body by the fastening member. With this configuration, the cutting insert can be pressed and fixed in a stable state without defects such as wear and deformation due to load concentration, and good cutting processing by the cutting insert can be achieved.

The bulging portion may have a curvature radius of an outer shape curved in an arc shape of 5 mm or more and 100 mm or less.

The bulging portion may have a curvature radius of an outer shape curved in an arc shape of 5 mm or more and 30 mm or less.

The bulging portion may be formed in parallel with the width direction of the fixing member body.

A fitting protrusion protruding from a bottom portion of a fixing member body and configured to be fitted into a fitting hole formed in a tool body, and an engagement recessed part formed on a peripheral surface of the fitting protrusion and configured to be engaged with a leading end of a fastening member that is screwed into a screw hole communicating with the fitting hole of the tool body may be included. A pressing portion may press and fix a cutting insert, with the fitting protrusion being pulled into the fitting hole by the fastening member engaged with an engagement recessed part.

A through screw hole formed in a fixing member body may be included. A right-hand/left-hand double ended thread may have screw portions having reverse threads in one end side and another end side respectively, the screw portion on the one end side being screwed into a female screw of a tool body, the screw portion on the other end side being screw-engaged with the through screw hole, and the tool body and the fixing member body are pulled toward each other by rotation of the right-hand/left-hand double ended thread in one rotation direction, and the tool body and the fixing member body are pulled away from each other by rotation of the right-hand/left-hand double ended thread in another rotation direction.

A cutting tool according to one aspect of the present invention includes a tool body including the fixing member and having an insert mounting part to which a cutting insert is disposed and a fixing member mounting part to which the fixing member is assembled, and the cutting insert disposed on the insert mounting part and pressed and fixed by the fixing member.

According to the present invention, there are provided a fixing member and a cutting tool capable of pressing and fixing a cutting insert to a tool body in a stable state without defects such as wear and deformation.

### BRIEF DESCRIPTION OF DRAWINGS

FIG. 1 is a side view of a cutting tool according to a first embodiment;

FIG. 2 is a perspective view of a leading end of the cutting tool according to the first embodiment;

FIG. 3 is a schematic side view of the cutting insert at a clamping position of a cutting insert;

FIG. 4 is a schematic perspective view of the clamping portion of the cutting insert as viewed from the rear side;

FIG. 5 is a perspective view of a leading end of the tool body in a state where the cutting insert is disposed in an insert mounting part;

FIG. 6 is a plan view of the leading end of the tool body in a state where the cutting insert is disposed in the insert mounting part;

FIG. 7 is a side view of the fixing member;

FIG. 8 is a perspective view of the fixing member;

FIG. 9 is a front view of the fixing member;

FIG. 10 is a perspective view of the fixing member as viewed from a lower rear side;

FIG. 11 is a perspective view of the fixing member in which a coil spring is attached to a leading end of a fitting protrusion as viewed from a back surface side;

FIG. 12 is a schematic side view of a section, in the fixing member, where the cutting insert is pressed with the pressing portion;

FIG. 13 is a plan view of the fixing member for explaining the shape of the fitting protrusion of the fixing member;

FIG. 14 is a perspective view of the fixing member illustrating an engagement state of a fixing screw with the engagement recessed part formed in the fitting protrusion of the fixing member;

FIG. 15 is a side view of a part of the fixing member having a guide projected part at a front portion of the fitting protrusion;

FIG. 16 is a side view of a cutting tool according to a second embodiment;

FIG. 17 is a perspective view of a leading end of the cutting tool according to the second embodiment;

FIG. 18 is a schematic side view of a cutting insert at a clamping position;

FIG. 19 is a perspective view of the leading end of the tool body in a state where the cutting insert is disposed in an insert mounting part;

FIG. 20 is a perspective view of a fixing member mounting part of the tool body;

FIG. 21 is a side view of the fixing member;

FIG. 22 is a perspective view of the fixing member;

FIG. 23 is a front view of the fixing member;

FIG. 24 is a perspective view of the fixing member as viewed from a lower rear side; and

FIG. 25 is a schematic side view of a section, in the fixing member, where the cutting insert is pressed with the pressing portion.

### DETAILED DESCRIPTION

Hereinafter, embodiments of the present invention will be described in detail with reference to the drawings.

### First Embodiment

First, a first embodiment will be described.

### Cutting Tool

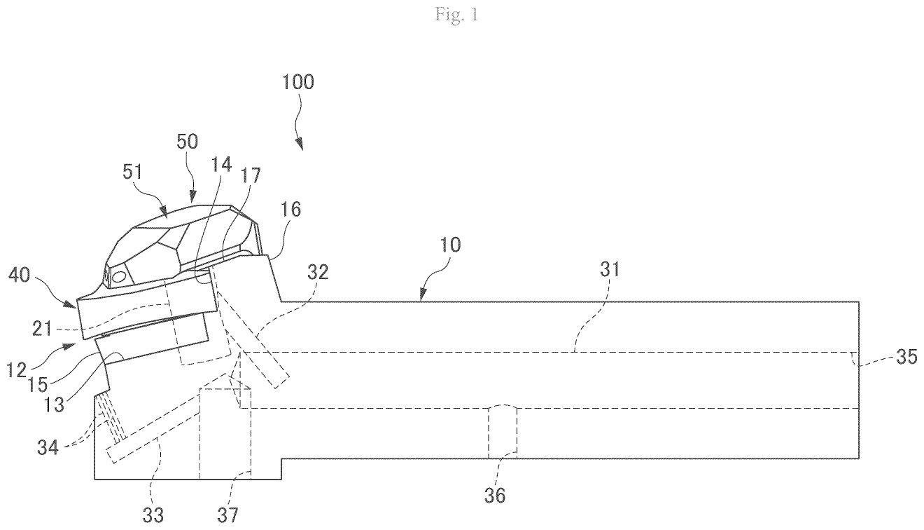

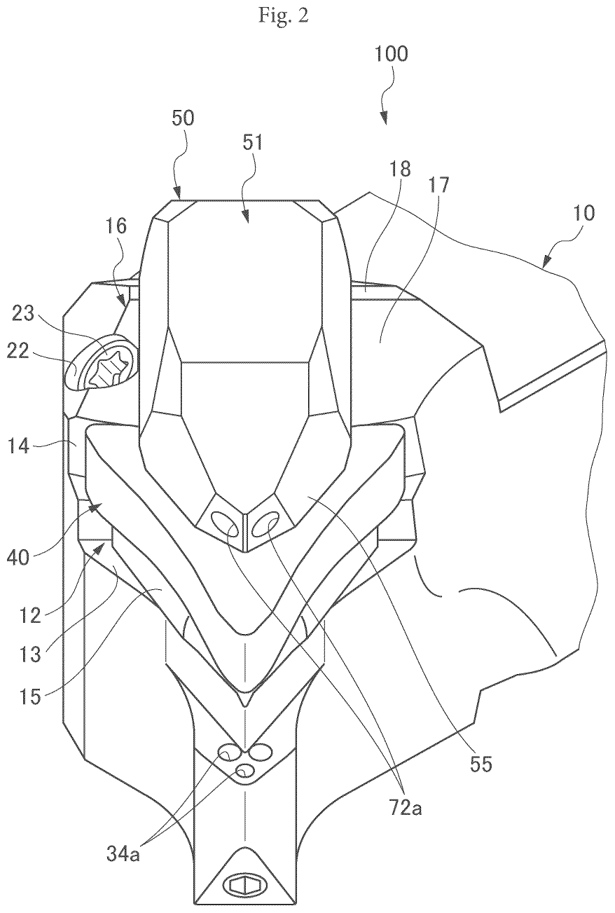

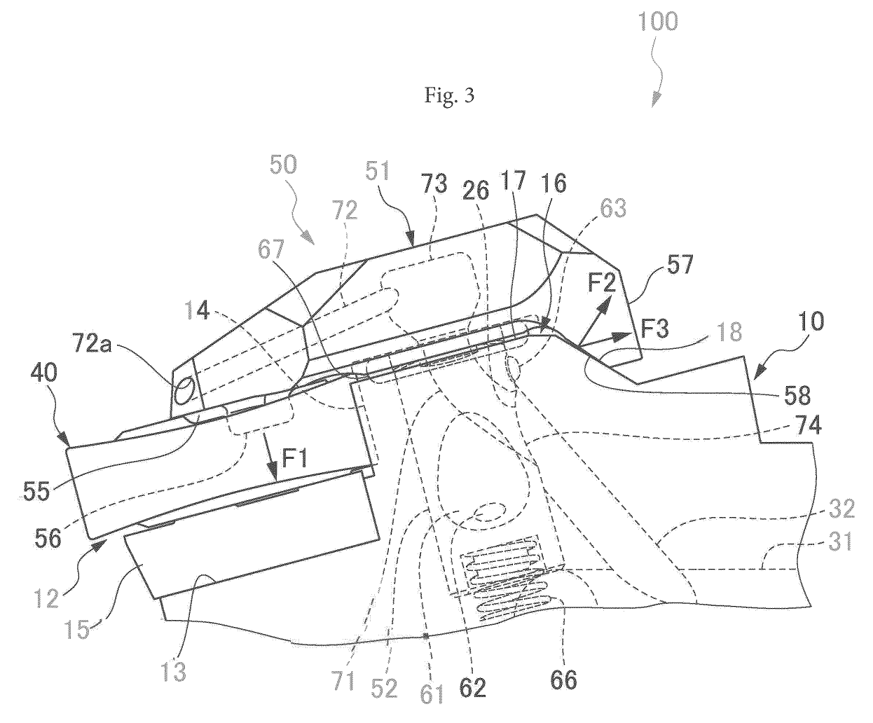

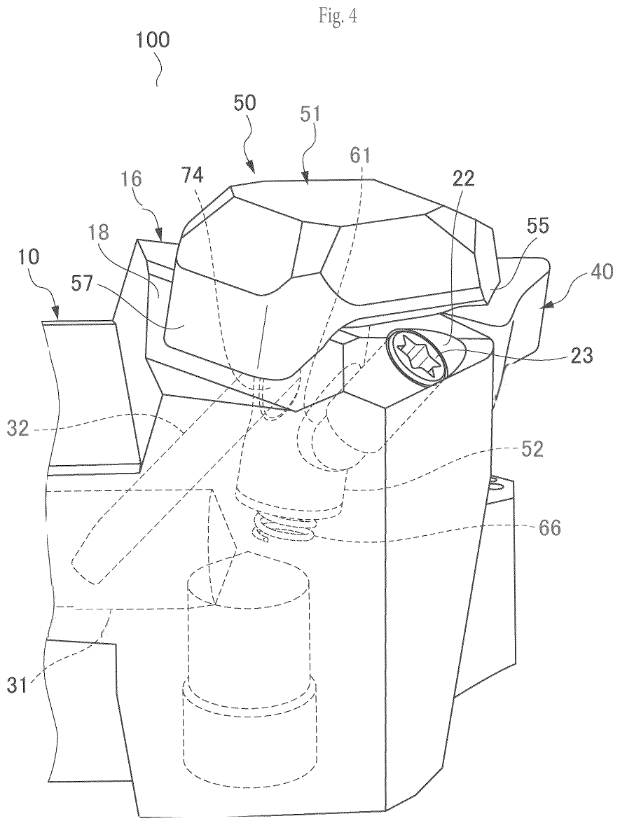

As illustrated in FIGS. 1 to 4, a cutting tool 100 according to the first embodiment includes a tool body 10 and a cutting insert 40, and the tool body 10 includes a fixing member 50 and a fixing screw 23. The cutting tool 100 is a turning tool in which the cutting insert 40 is attached to a leading end of the tool body 10, and an outer diameter cutting or an inner diameter cutting is performed on a rotating workpiece by the cutting insert 40 at the leading end of the tool body 10. The cutting insert 40 is pressed and fixed by the fixing member 50 of the tool body 10.

### Tool Body

The tool body 10 is formed in a prismatic shape and has the cutting insert 40 attached to the leading end thereof. The tool body 10 has an insert mounting part 12 at the leading end thereof, and the cutting insert 40 is attached to the insert mounting part 12. The tool body 10 is formed of, for example, a metal material such as a steel material. As a material of the tool body 10, for example, an alloy tool steel material (SKS5), die steel (SKD61), maraging steel, or the like which has elasticity and is hardly plastically deformed is preferable. The shape of the tool body 10 is not limited to a prismatic shape.

The insert mounting part 12 has an attachment surface 13 and a side wall surface 14 provided on the rear side of the attachment surface 13 so as to stand substantially perpendicularly to the attachment surface 13. In the insert mounting part 12, a cutting insert 40 is disposed on the attachment surface 13 via a shim 15. Note that a structure in which the cutting insert 40 is disposed on the attachment surface 13 without providing the shim 15 may be adopted.

In the tool body 10, a rear side of the insert mounting part 12 serves as a fixing member mounting part 16, and the fixing member 50 is mounted to the fixing member mounting part 16. The fixing member mounting part 16 has a mounting surface 17 formed of a flat surface connected to the side wall surface 14 of the insert mounting part 12. The fixing member mounting part 16 has a sliding surface 18 on the rear side of the mounting surface 17. The sliding surface 18 is an inclined surface that gradually inclines downward from the mounting surface 17 side toward the rear side.

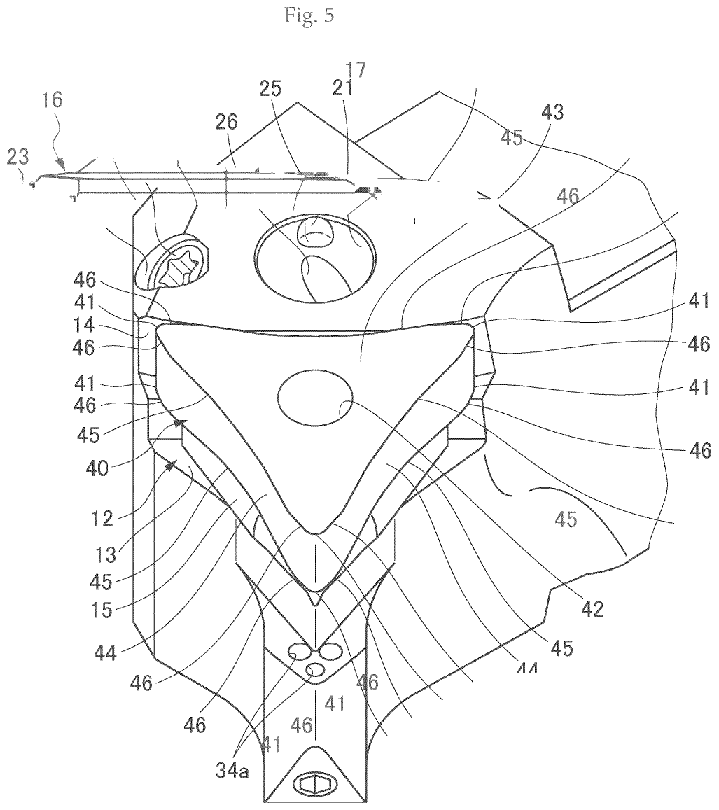

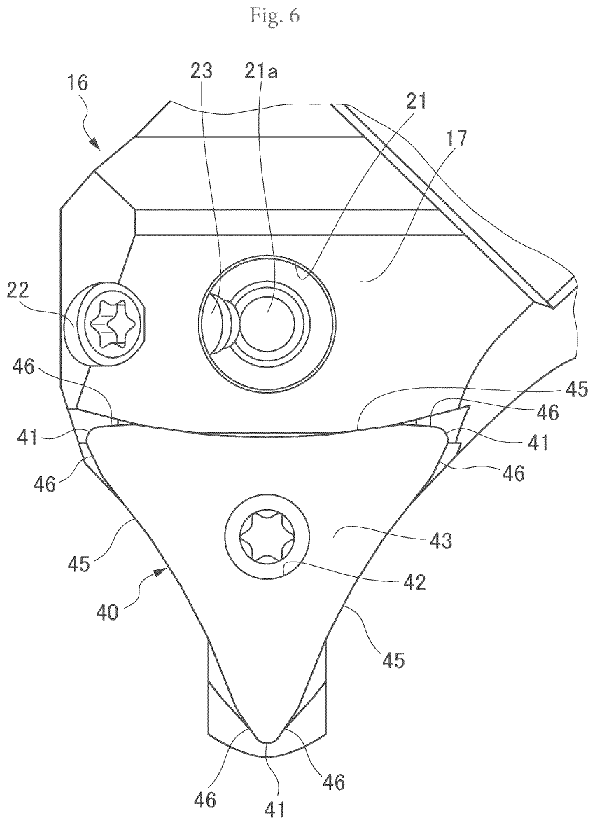

As illustrated in FIGS. 5 and 6, the fixing member mounting part 16 has a fitting hole 21 and a female screw 22. The fitting hole 21 is formed perpendicular to the mounting surface 17. The female screw 22 opens on the side of the fitting hole 21 and is formed obliquely toward the fitting hole 21. The female screw 22 communicates with the fitting hole 21 on the inner peripheral surface. A fixing screw (fastening member) 23 is screwed into the female screw 22 from the upper side of the fixing member mounting part 16, and the leading end of the female screw 22 protrudes into the fitting hole 21. As the fixing screw 23, a set screw is used. In this example, a structure in which the fixing screw 23 is screwed into the female screw 22 is exemplified, but a hole communicating with the fitting hole 21 may be formed instead of the female screw 22, and a pressing member such as a pin may be inserted into the hole by an operation of a cam or a lever.

A guide recessed part 25 is formed on the inner peripheral surface of the fitting hole 21. The guide recessed part 25 is provided on the side opposite to the insert mounting part 12 and is formed in a spherical concave shape. Further, an outflow port 26 is formed on an inner peripheral surface of the fitting hole 21. The outflow port 26 is also provided on the side opposite to the insert mounting part 12 and below the guide recessed part 25.

As illustrated in FIG. 1, the tool body 10 having the insert mounting part 12 and the fixing member mounting part 16 at the leading end portion has a coolant main flow path 31, coolant branch flow paths 32 and 33, and a plurality of coolant discharge flow paths 34 therein.

The coolant main flow path 31 is formed along the longitudinal direction of the tool body 10. The coolant main flow path 31 has a plurality of inflow ports 35, 36, and 37. The inflow port 35 is formed in the rear end surface of the tool body 10, the inflow port 36 is formed in the bottom surface at the center in the longitudinal direction of the tool body 10, and the inflow port 37 is formed in the bottom surface on the leading end side of the tool body 10. Then, the coolant is supplied from any one of the inflow ports 35,36, and 37 to the coolant main flow path 31, and portions of the inflow ports 35,36, and 37 that are not used to supply the coolant are sealed with a set screw or the like.

The coolant branch flow path 32 is formed in an upper portion on the leading end side of the tool body 10, and has one end communicating with the coolant main flow path 31. The other end of the coolant branch flow path 32 communicates with the fitting hole 21, and an opening portion thereof serves as an outflow port 26. The coolant supplied to the coolant main flow path 31 is fed into the coolant branch flow path 32. The fluid to be supplied to the coolant main flow path 31 is not limited to the coolant, and various lubricants and cooling media can be used, and mist or air may be supplied.

The coolant branch flow path 33 is formed in a lower portion on the leading end side of the tool body 10, and has one end communicating with the coolant main flow path 31. One ends of the plurality of coolant discharge flow paths 34 communicate with the other end of the coolant branch flow path 33. The other end of the coolant discharge flow paths 34 are opened at the leading end of the tool body 10, and the opening portions serve as discharge ports 34a. The coolant supplied to the coolant main flow path 31 is fed into the coolant branch flow path 33. The coolant fed into the coolant branch flow path 33 passes through the coolant discharge flow paths 34, is discharged from the discharge ports 34a, and cools and lubricates the vicinity of a flank of the cutting insert 40.

### Cutting Insert

As illustrated in FIGS. 5 and 6, the cutting insert 40 mounted to the insert mounting part 12 of the tool body 10 is formed in, for example, a flat substantially triangular three-dimensional shape. The cutting insert 40 has end surfaces 43 on the front and back sides, and each end surface 43 has three corner portions 41. The cutting insert 40 has a fixing hole 42 at the center thereof.

The cutting insert 40 has substantially triangular end surfaces 43 facing each other and three peripheral side surfaces 44 connecting these end surfaces 43. In this cutting insert 40, the vicinity of each corner portion 41 is a cutting edge 46 at the ridge line 45 between each end surface 43 and the peripheral side surfaces 44.

The cutting insert 40 is placed and fixed on the insert mounting part 12 of the tool body 10 in a state where one of the end surfaces 43 is directed upward and one of the three corner portions 41 is directed in the leading end direction. As described above, the cutting insert 40 can be cut at a total of six places by using any one of the three corner portions 41 having the cutting edges 46 in the leading end direction on each end surface 43.

### Fixing Member

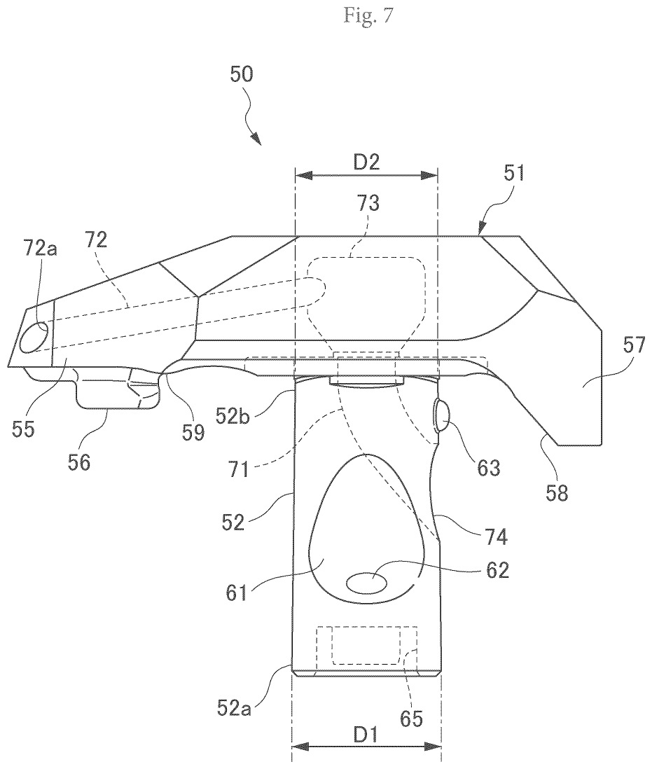

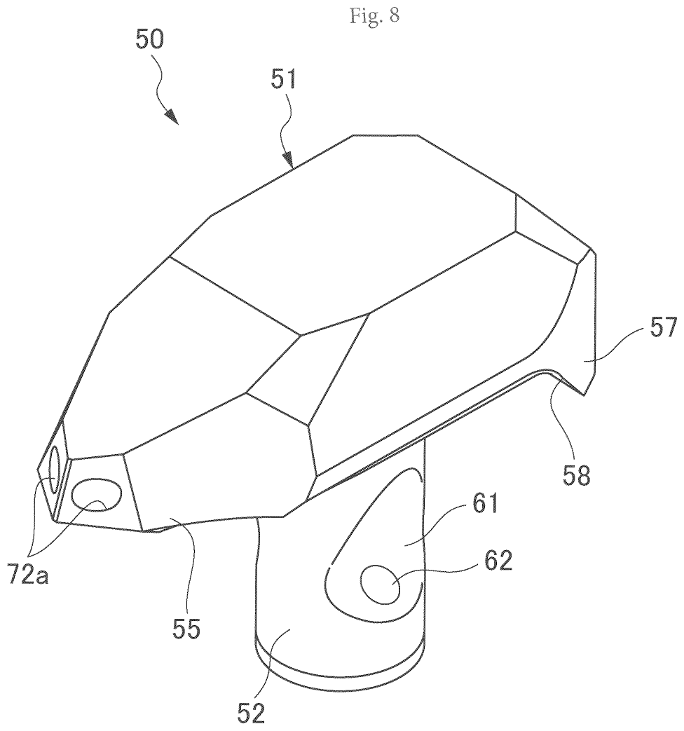

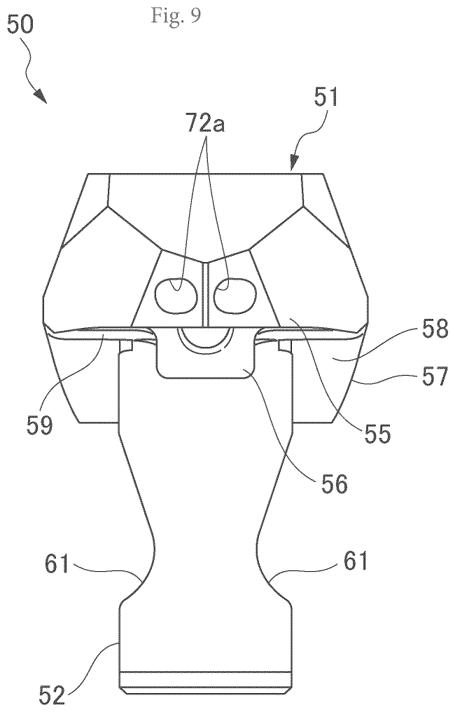

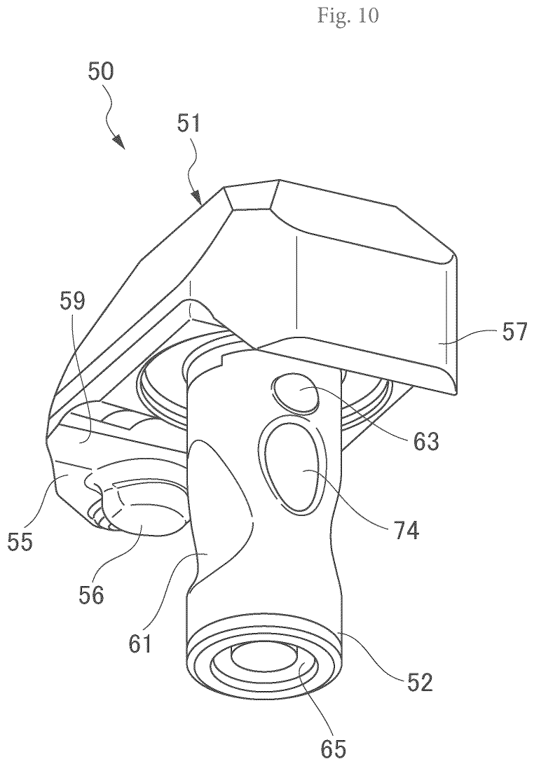

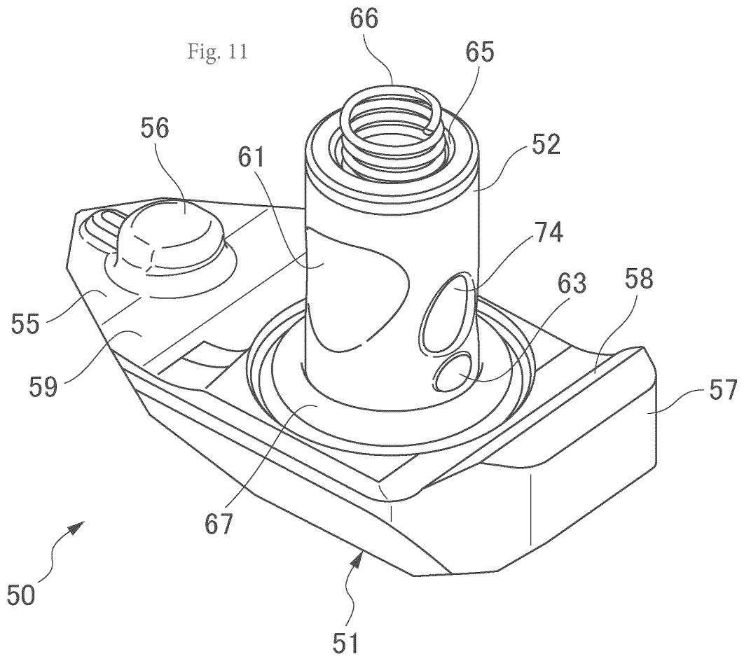

As illustrated in FIGS. 7 to 11, the fixing member 50 includes a fixing member body 51 and a fitting protrusion 52. The fitting protrusion 52 extends downward from the bottom of the fixing member body 51.

The leading end side of the fixing member body 51 with respect to the fitting protrusion 52 is a pressing portion 55, and the pressing portion 55 is formed with a pressing protrusion 56 protruding downward. The pressing protrusion 56 is a protrusion for fixing the cutting insert 40, and may have any shape as long as it can press the inner peripheral surface of the fixing hole 42 of the cutting insert. Further, the fixing member body 51 has a sliding surface 58 that gradually inclines downward to the rear side on a rear end portion 57 side with respect to the fitting protrusion 52.

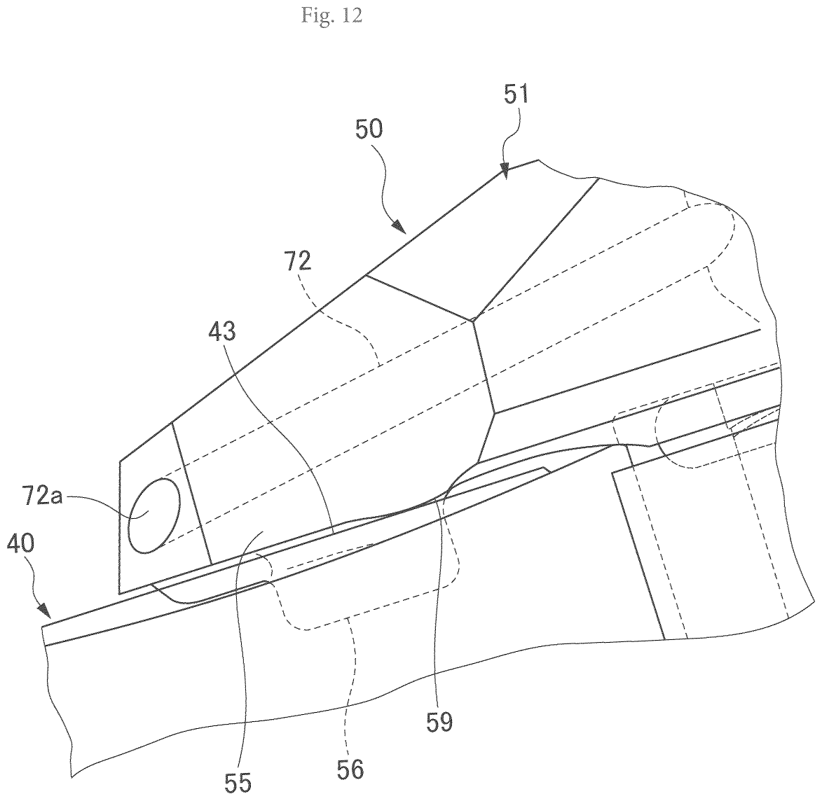

A bulging portion 59 is formed in the pressing portion 55 of the fixing member body 51. As illustrated in FIG. 12, the bulging portion 59 is formed so as to bulge from the bottom portion of the fixing member body 51, and is formed along the width direction of the fixing member body 51. The bulging portion 59 is preferably parallel to the width direction of the fixing member body 51. The bulging portion 59 has an outer shape curved in an arc shape in a cross-sectional view in a direction orthogonal to the width direction of the fixing member body 51. The smaller the curvature radius R of the arcuately curved outer shape of the bulging portion 59, the more the contact is made with the target position, but if the curvature radius R is too small, the contact area decreases. In addition, a larger curvature radius R causes the elastic contact area increases, but it is difficult to stably make contact with the position as designed. Therefore, the curvature radius R of the arcuately curved outer shape of the bulging portion 59 is 5 mm (R5) or more and 100 mm (R100) or less, and preferably 5 mm (R5) or more and 30 mm (R30) or less.

The fitting protrusion 52 is formed in a columnar shape. The fitting protrusion 52 has engagement recessed parts 61 on both sides thereof. The engagement recessed parts 61 are formed in a recessed shape gradually inclined toward the center side in the protruding direction of the fitting protrusion 52. A contact projected part 62 protruding in a spherical convex shape is formed at the bottom of the engagement recessed part 61. On the rear side of the fitting protrusion 52, a spherical convex guide projected part 63 is formed in the vicinity of the base portion. Further, the fitting protrusion 52 has an annular recessed part 65 at the leading end thereof, and a coil spring 66 is fitted and attached to the annular recessed part 65. An annular O-ring 67 is attached to a base portion of the fitting protrusion 52.

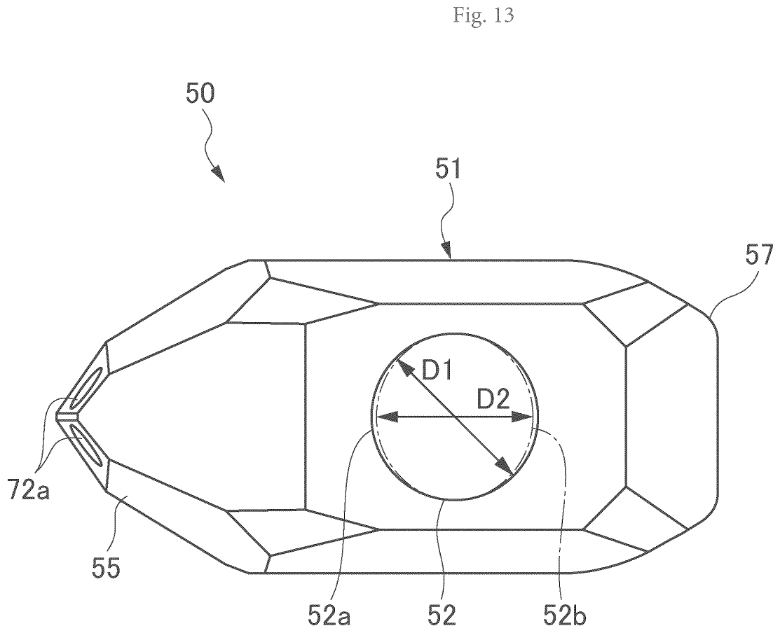

As illustrated in FIG. 13, a leading end 52a of the fitting protrusion 52 is formed in a circular shape having an outer diameter D1. On the other hand, the base end 52b side of the fitting protrusion 52 is formed in an elliptical shape having a major diameter D1 and a minor diameter D2, and the front-rear direction of the fixing member 50 is the minor axis direction. Accordingly, the dimension of the fitting protrusion 52 in the front-rear direction gradually decreases from the leading end 52a toward the base end 52b.

The fixing member 50 includes a coolant introduction flow path 71, a coolant discharge flow paths 72, and a coolant reservoir 73. The coolant introduction flow path 71, the coolant discharge flow paths 72, and the coolant reservoir 73 constitute a coolant flow path in the fixing member 50. One end of the coolant introduction flow path 71 is opened on the leading end side of the guide projected part 63 on the rear side of the fitting protrusion 52, and this opening portion is the inflow port 74. The coolant introduction flow path 71 is formed toward the fixing member body 51 while curving the fitting protrusion 52 upward from the inflow port 74. In this example, two coolant discharge flow paths 72 are formed. The coolant discharge flow paths 72 are disposed, for example, in parallel on the leading end side of the fixing member body 51 and formed along the front-rear direction, and are opened at the leading end of the fixing member body 51. The opening portions of the coolant discharge flow paths 72 are discharge ports 72a. The coolant reservoir 73 is formed at a position above the fitting protrusion 52 in the fixing member body 51. The coolant introduction flow path 71 and the coolant discharge flow paths 72 communicate with the coolant reservoir 73. The coolant reservoir 73 has a flow path cross section larger than the coolant introduction flow path 71 and the coolant discharge flow paths 72. Note that the two coolant discharge flow paths 72 are not limited to those arranged in parallel.

### Fixation of Cutting Insert

Next, a case where the cutting insert 40 disposed in the insert mounting part 12 of the tool body 10 is fixed by the fixing member 50 will be described.

First, with respect to the tool body 10 in which the cutting insert 40 is disposed in the insert mounting part 12, the fitting protrusion 52 of the fixing member 50 is inserted into the fitting hole 21 of the fixing member mounting part 16, and the fixing member body 51 is disposed on the upper portion of the fixing member mounting part 16. Then, the pressing protrusion 56 formed on the pressing portion 55 of the fixing member body 51 is fitted into the fixing hole 42 of the cutting insert 40. At this time, the coil spring 66 at the leading end of the fitting protrusion 52 is brought into contact with the bottom portion 21a of the fitting hole 21.

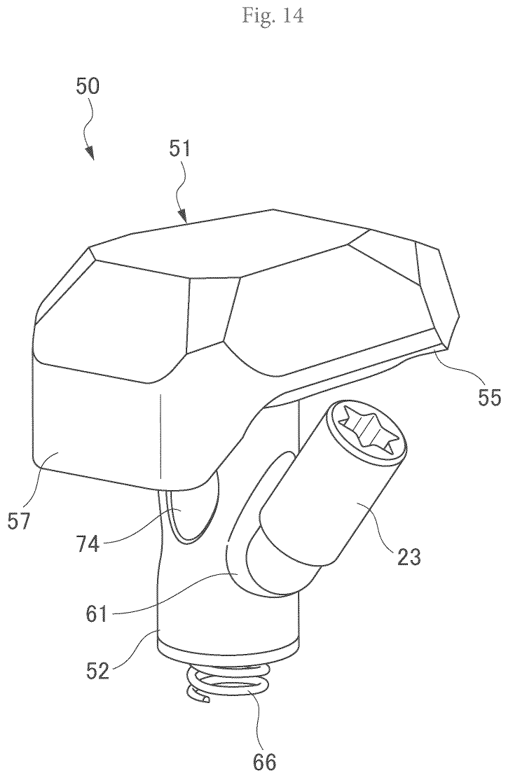

In this state, the fixing screw 23 is screwed into the female screw 22 of the fixing member mounting part 16 of the tool body 10. Then, as illustrated in FIG. 14, the leading end of the fixing screw 23 protrudes into the fitting hole 21 and is inserted into one of the engagement recessed parts 61 formed in the fitting protrusion 52, and comes into contact with the contact projected parts 62 formed at the bottom of the engagement recessed parts 61. By further screwing the fixing screw 23, the fitting protrusion 52 is drawn into the fitting hole 21 against the biasing force of the coil spring 66 by the fastening force of the fixing screw 23. As a result, the fixing member 50 is pressed toward the fixing member mounting part 16 of the tool body 10. Then, by the pressing portion 55 of the fixing member 50, the cutting insert 40 is pressed against the shim 15 of the insert mounting part 12 of the tool body 10 by the pressing force F1.

Here, when the fixing member 50 is fastened to the tool body 10 by the fixing screw 23, the bulging portion 59 having the outer shape curved in an arc shape in a cross-sectional view and formed along the width direction of the fixing member body 51 comes into contact with the upper end surface 43 of the cutting insert 40, and the cutting insert 40 is pressed and fixed by the bulging portion 59 (see FIG. 12). As a result, the cutting insert 40 is pressed and fixed in a stable state by the fixing member 50 without defects such as wear and deformation due to load concentration.

When the fixing member 50 is pressed against the fixing member mounting part 16, the sliding surface 58 of the fixing member body 51 comes into contact with the sliding surface 18 of the tool body 10 and slides. Then, the fixing member 50 is pulled rearward of the tool body 10 by the component force F3 of the reaction force F2 from the sliding surface 18 of the tool body 10. As a result, the pressing protrusion 56 fitted into the fixing hole 42 of the cutting insert 40 moves rearward while contacting the inner peripheral surface of the fixing hole 42. Therefore, the cutting insert 40 is pulled toward the rear side of the insert mounting part 12 of the tool body 10 by the pressing protrusion 56 of the fixing member 50 and is pressed against the side wall surface 14. As described above, the cutting tool 100 has a double clamp fixing system in which the fixing member 50 presses two positions of the upper end surface 43 of the cutting insert 40 and the inner peripheral surface of the fixing hole 42.

Here, in the fitting protrusion 52 of the fixing member 50, the base end 52b having an elliptical shape has a smaller dimension in the front-rear direction than the leading end 52a. Therefore, in the front-rear direction of the fixing member 50, a gap that gradually increases toward the base end 52b side of the fitting protrusion 52 is formed between the fitting protrusion 52 and the fitting hole 21. With this configuration, when the fitting protrusion 52 is drawn into the fitting hole 21 by the fixing screw 23, the fixing member 50 is naturally displaced rearward of the tool body 10. The fitting protrusion 52 may have an elliptical shape in which the front-rear direction of the fixing member 50 is the minor diameter direction over the entire length. In this case, by making the dimension of the minor diameter on the base end 52b side smaller than the minor diameter on the leading end 52a side, a gap gradually increasing toward the base end 52b side of the fitting protrusion 52 can be formed between the fitting protrusion 52 and the fitting hole 21 in the front-rear direction of the fixing member 50, and the fixing member 50 fitted in the fitting hole 21 can be displaced rearward of the tool body 10 without difficulty.

In the clamped state where the cutting insert 40 is fixed to the insert mounting part 12, the guide projected part 63 formed on the fitting protrusion 52 of the fixing member 50 is fitted into the guide recessed part 25 formed in the fitting hole 21 of the tool body 10. As a result, the fixing member 50 is prevented from rotating about the axis of the fitting protrusion 52 of the fixing member 50 by the guide projected part 63 and the guide recessed part 25 fitted to each other. Therefore, fluctuation of the fixing member 50 at the time of cutting by the cutting insert 40 of the cutting tool 100 is suppressed, and preferable cutting by the cutting insert 40 is achieved.

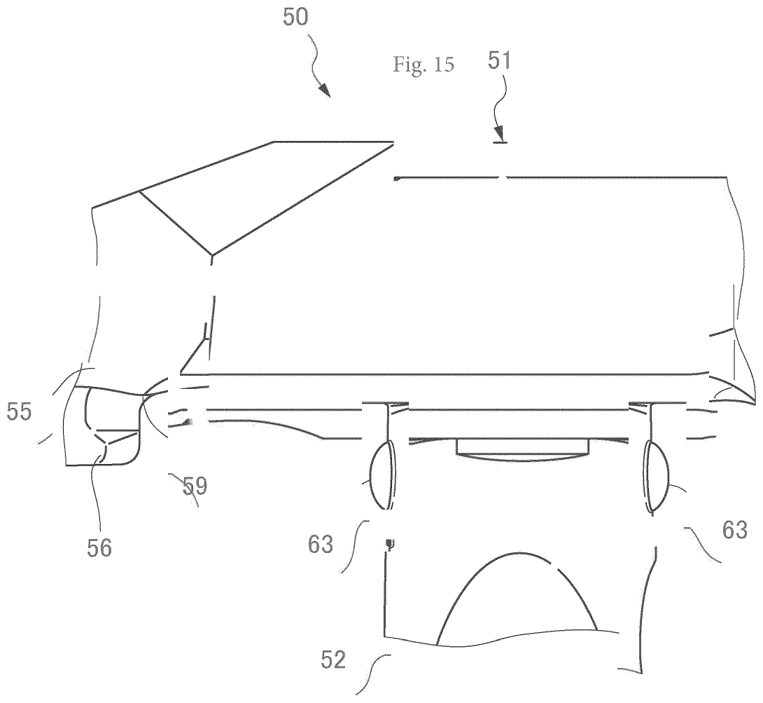

As illustrated in FIG. 15, the guide projected part 63 may also be provided on the front portion side of the fitting protrusion 52 of the fixing member 50. In this case, the guide recessed part 25 to which the guide projected part 63 provided on the front portion side of the fitting protrusion 52 can be fitted is provided on the insert mounting part 12 side in the fitting hole 21. As a result, the rotation-preventing effect of the fixing member 50 around the axis of the fitting protrusion 52 can be further enhanced.

In the clamped state where the cutting insert 40 is fixed to the insert mounting part 12, the O-ring 67 attached to the base of the fitting protrusion 52 of the fixing member 50 comes into close contact with the mounting surface 17 of the fixing member mounting part 16 of the tool body 10. With such a configuration, a space between the bottom portion of the fixing member 50 and the mounting surface 17 of the fixing member mounting part 16 is sealed.

Further, in a clamped state where the cutting insert 40 is fixed to the insert mounting part 12, the inflow port 74 of the coolant introduction flow path 71 formed in the fitting protrusion 52 of the fixing member 50 communicates with the outflow port 26 of the coolant branch flow path 32 which is a supply path formed in the fitting hole 21 of the tool body 10. With this configuration, the coolant fed from the coolant main flow path 31 to the coolant branch flow path 32 is fed to the coolant introduction flow path 71 of the fixing member 50. The coolant fed to the coolant introduction flow path 71 is fed to the coolant discharge flow paths 72 through the coolant reservoir 73, and is discharged from the discharge ports 72a at the leading end of the fixing member 50. As a result, the coolant discharged from the discharge ports 72a at the leading end of the fixing member 50 is blown to the cutting place by the cutting insert 40 together with the coolant discharged from the discharge ports 34a at the leading end of the tool body 10. As a result, the cutting place by the cutting insert 40 is favorably cooled and lubricated. Here, the coolant reservoir 73 having a large flow path cross section is provided between the coolant introduction flow path 71 and the coolant discharge flow paths 72. With this configuration, the pressure loss of the coolant when the coolant is fed from the coolant introduction flow path 71 to the coolant discharge flow paths 72 having a small inner diameter can be suppressed, and the coolant can be satisfactorily discharged from the discharge ports 72a.

### Removal of Cutting Insert

Next, a case of removing the cutting insert 40 fixed to the insert mounting part 12 of the tool body 10 by the fixing member 50 will be described.

In order to remove the cutting insert 40, first, the fixing screw 23 fixing the fixing member 50 is loosened. Then, the fixing screw 23 is pulled out from the engagement recessed part 61 of the fixing member 50. Then, the fixing member 50 is pushed up in a direction away from the fixing member mounting part 16 of the tool body 10 by the elastic force of the coil spring 66 at the leading end of the fitting protrusion 52. As a result, the fixation of the cutting insert 40 by the fixing member 50 is released. As described above, when the fixing member 50 is pushed up by the coil spring 66, the guide projected part 63 of the fitting protrusion 52 fitted in the guide recessed part 25 of the fitting hole 21 slides with the guide recessed part 25. As a result, the rear side of the fixing member 50 is guided along the contact surface between the guide projected part 63 and the guide recessed part 25, and the rear portion of the fixing member 50 is smoothly pushed up. Therefore, the fixing member 50 whose rear portion is pushed up from the fixing member mounting part 16 of the tool body 10 can be easily gripped and removed.

As described above, according to the fixing member 50 of the first embodiment, by being fastened to the tool body 10 by the fixing screw 23, the cutting insert 40 is pressed and fixed by the bulging portion 59 having an outer shape curved in an arc shape in a cross-sectional view and formed along the width direction of the fixing member body 51. As a result, as compared with a case where the cutting insert 40 is pressed by a smooth surface or a plurality of spherical protrusions, the cutting insert 40 can be pressed and fixed in a stable state without defects such as wear and deformation due to concentration of load, and good cutting processing by the cutting insert 40 can be performed.

In particular, by setting the curvature radius R of the arcuately curved outer shape of the bulging portion 59 to 5 mm or more and 100 mm or less, preferably 5 mm or more and 30 mm or less, the cutting insert 40 can be pressed in a stable state while further suppressing the concentration of the load.

### Second Embodiment

Next, a second embodiment will be described.

The same components as those of the first embodiment are denoted by the same reference numerals, and the description thereof will be omitted.

### Cutting Tool

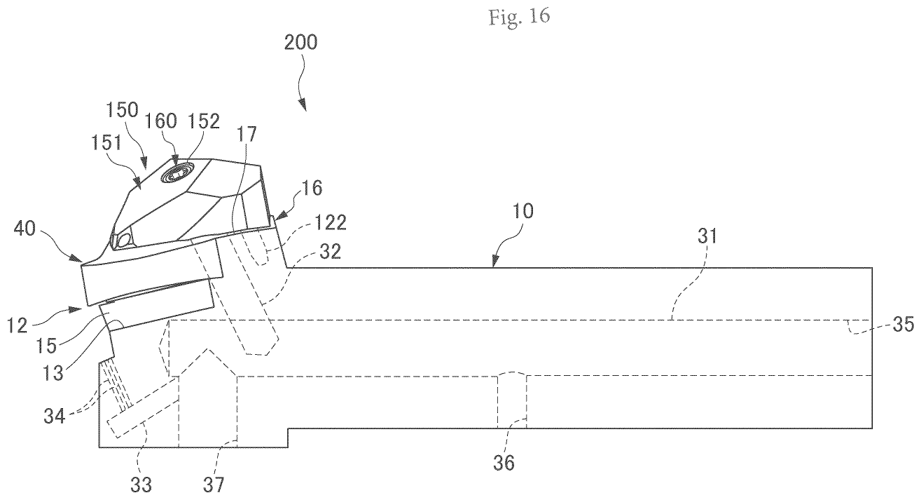

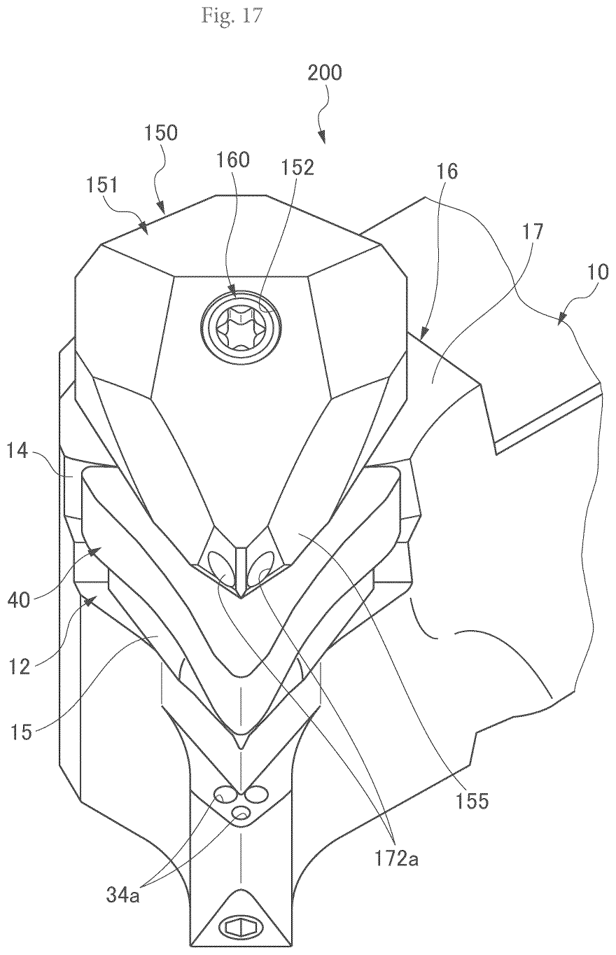

As illustrated in FIGS. 16 to 18, a cutting tool 200 according to the second embodiment is a turning tool including a tool body 10 and a cutting insert 40, and the tool body 10 includes a fixing member 150 and right-hand/left-hand double ended thread 160. The cutting insert 40 is pressed by the fixing member 150 to be fixed to the tool body 10.

### Tool Body

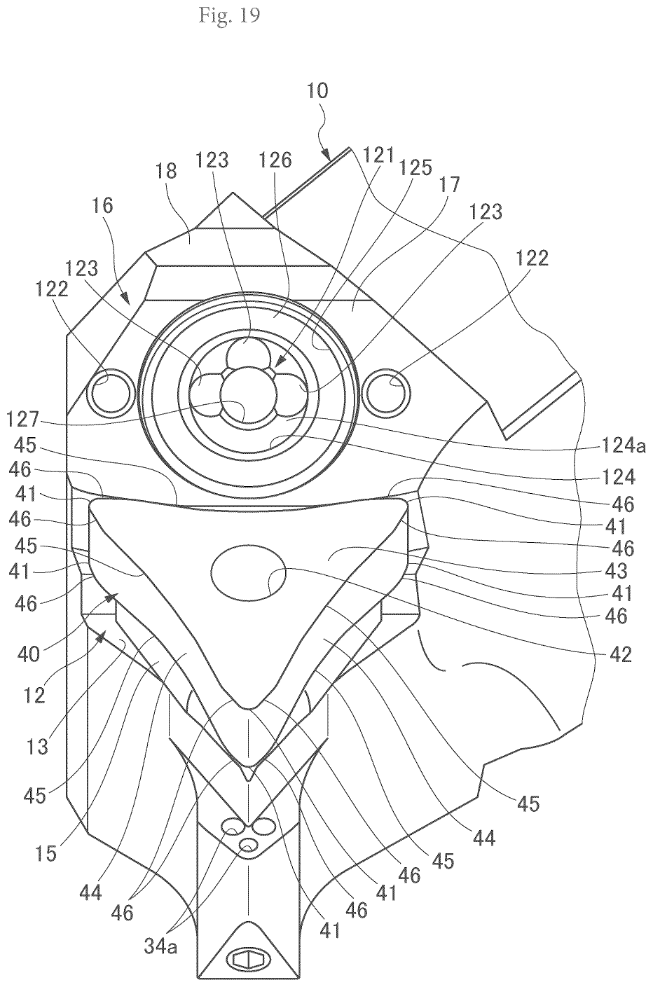

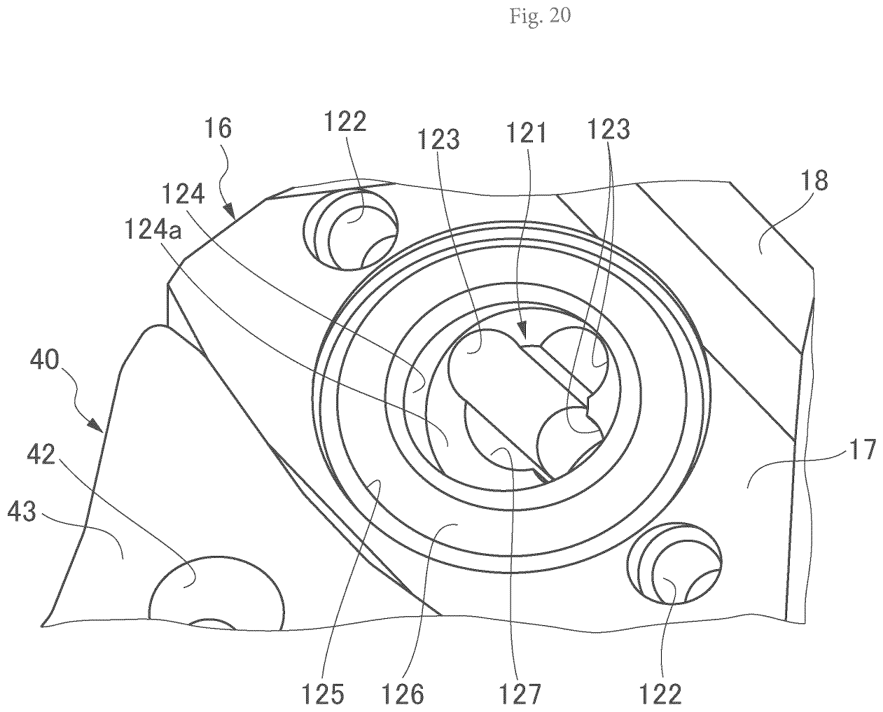

As illustrated in FIGS. 19 and 20, a fixing member mounting part 16 of the tool body 10 has a flow-path screw hole 121 and a plurality of (two in this example) engagement holes 122. Each of the flow-path screw hole 121 and the engagement holes 122 are formed in a mounting surface 17 of the fixing member mounting part 16, and the engagement holes 122 are formed on both sides of the flow-path screw hole 121. The flow-path screw hole 121 is inclined rearward toward the lower side of the tool body 10 with respect to the mounting surface 17. The engagement holes 122 are formed along the axis of the flow-path screw hole 121, whereby these engagement holes 122 are also inclined rearward toward the lower side of the tool body 10 with respect to the mounting surface 17.

The flow-path screw hole 121 has a female screw 127 and a plurality of (three in this example) coolant introduction flow paths 123 formed around the female screw 127. Specifically, these coolant introduction flow paths 123 are formed along the flow-path screw hole 121 on both sides and the rear side around the flow-path screw hole 121.

A recessed part 124 is formed on the mounting surface 17 of the fixing member mounting part 16. The recessed part 124 is formed in a range including the flow-path screw hole 121 including the female screw 127 and the coolant introduction flow path 123, and the flow-path screw hole 121 and the coolant introduction flow paths 123 are formed perpendicular to a bottom surface 124a of the recessed part 124. An annular recessed part 125 surrounding the periphery of the recessed part 124 is formed in the mounting surface 17 of the fixing member mounting part 16, and an O-ring 126 is fitted and attached to the annular recessed part 125.

### Fixing Member

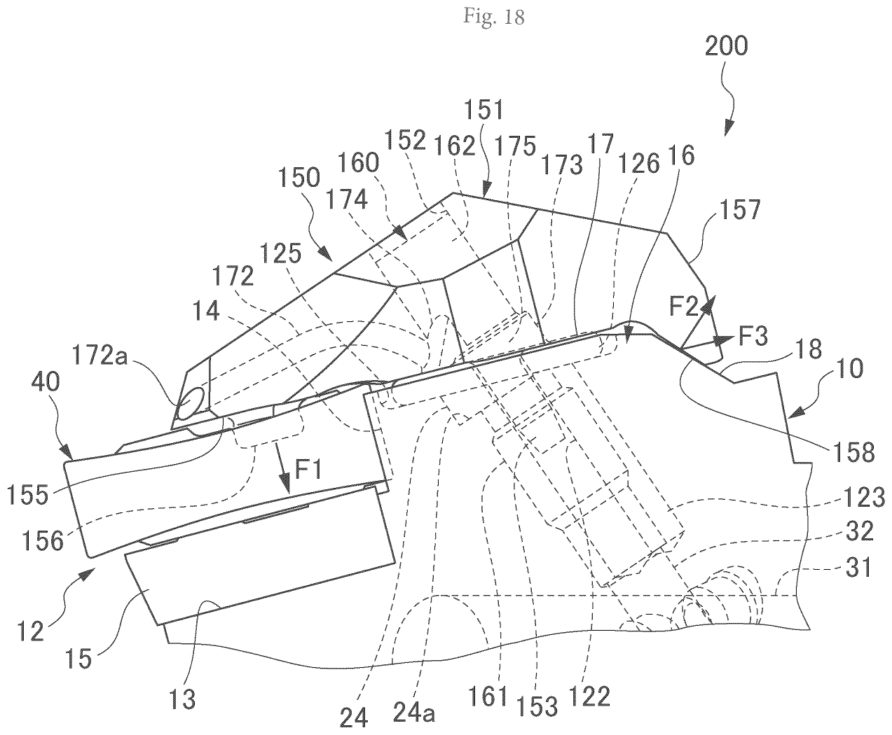

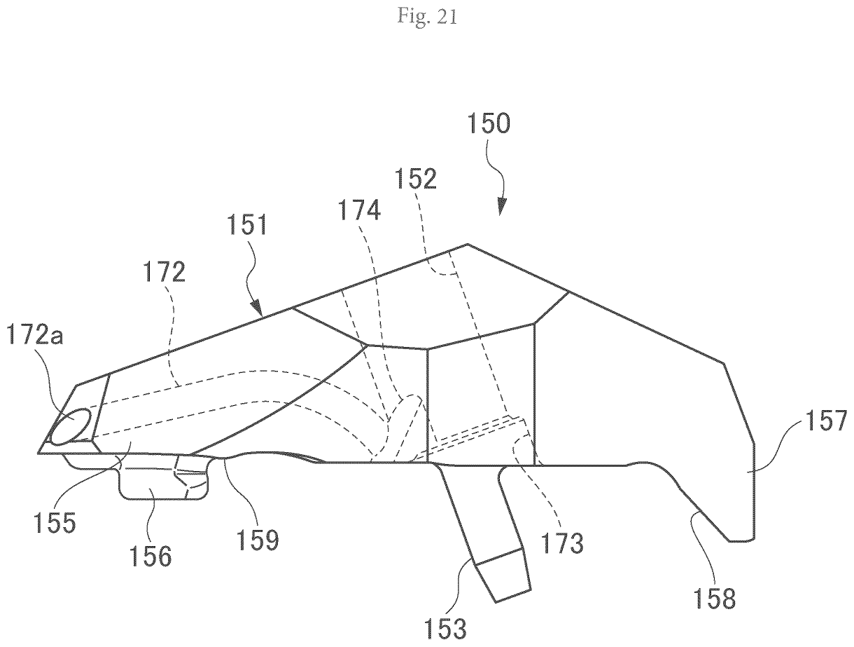

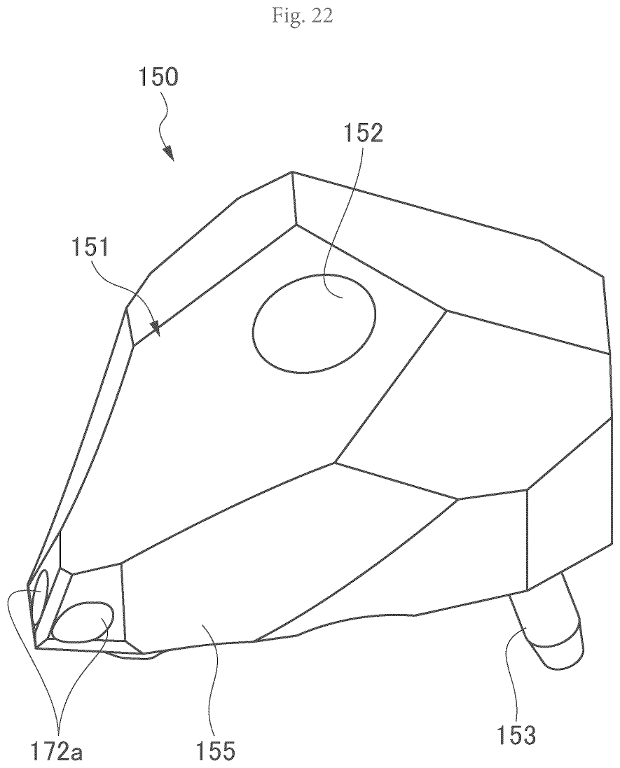

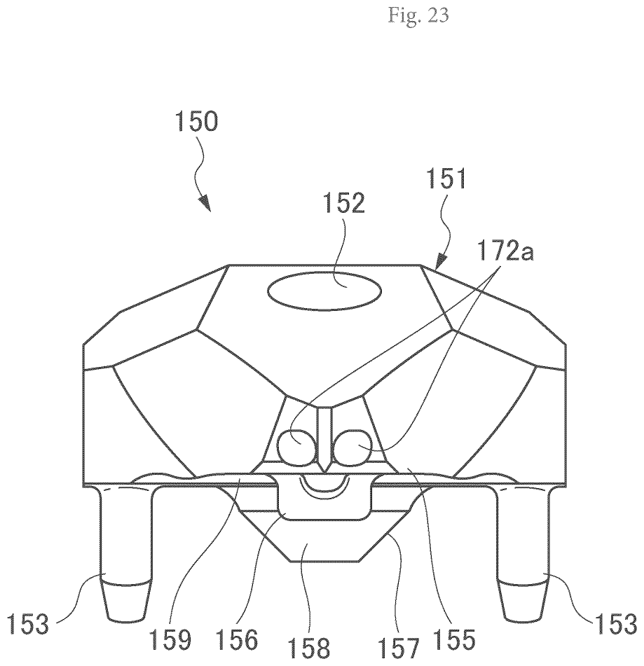

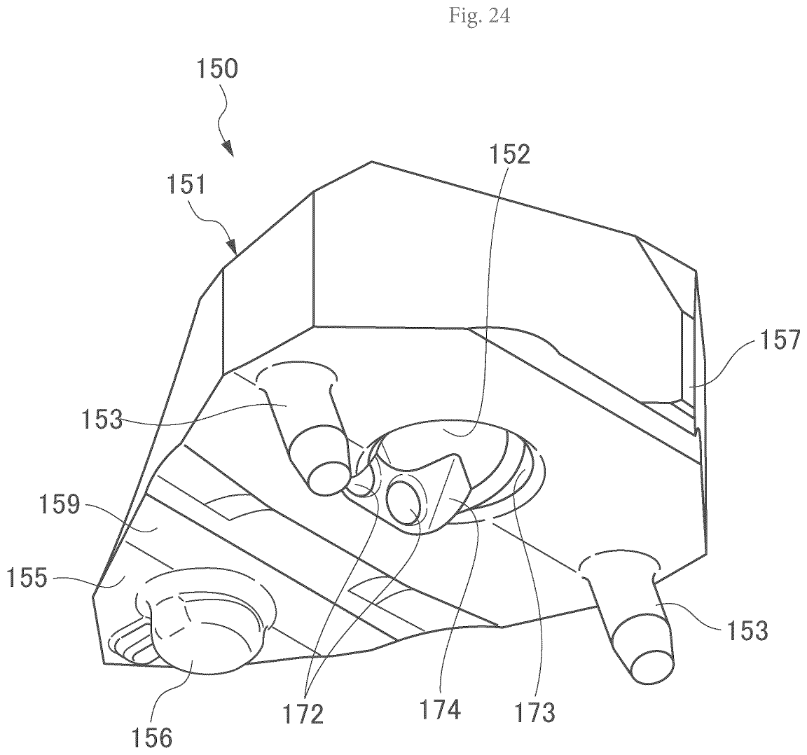

As illustrated in FIGS. 21 to 24, the fixing member 150 includes a fixing member body 151, a through screw hole 152, and engagement protrusions 153, and a right-hand/left-hand double ended thread (fastening member) 160 is screwed into the through screw hole 152 of the fixing member 50 (see FIG. 18). The through screw hole 152 is a screw hole penetrating the front and back of the fixing member body 151, and has a female screw in a direction opposite to the female screw 127 of the flow-path screw hole 121 of the tool body 10. The right-hand/left-hand double ended thread 160 is screwed and attached to the through screw hole 152.

The engagement protrusions 153 are formed on both sides of the through screw hole 152 in the fixing member body 151, and protrude from the bottom of the fixing member body 151. These engagement protrusions 153 protrude along the axis of the through screw hole 152, and the axes of the through screw hole 152 and the engagement protrusions 153 are parallel to each other. The leading end side of the fixing member body 151 with respect to the through screw hole 152 serves as a pressing portion 155, and the pressing portion 155 has a pressing protrusion 156 protruding downward. The pressing protrusion 156 is a protrusion for fixing the cutting insert 40, and may have any shape as long as it can press the inner peripheral surface of a fixing hole 42 of the cutting insert. Further, the fixing member body 151 has a sliding surface 158 that gradually inclines downward to the rear side on the rear end portion 157 side with respect to the through screw hole 152. The axes of the through screw hole 152 and the engagement protrusions 153 are inclined downward with respect to the bottom surface of the fixing member body 151 to the side opposite to the pressing portion 155.

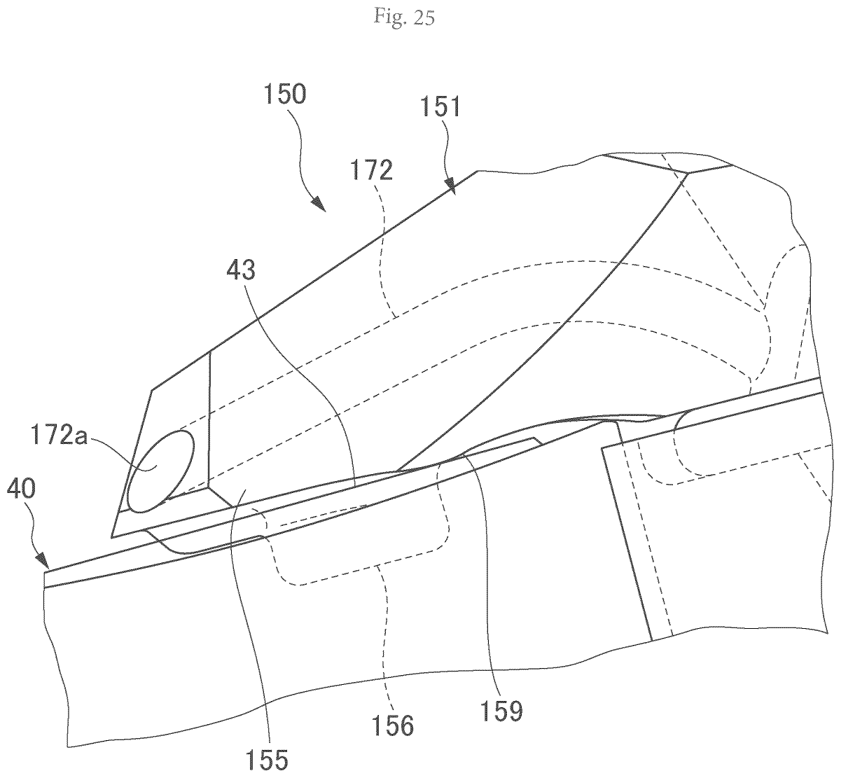

A bulging portion 159 is formed in the pressing portion 155 of the fixing member body 151. As illustrated in FIG. 25, the bulging portion 159 is formed so as to bulge from the bottom portion of the fixing member body 151, and is formed along the width direction of the fixing member body 151. The bulging portion 159 is preferably parallel to the width direction of the fixing member body 151. The bulging portion 159 has an outer shape curved in an arc shape in a cross-sectional view in a direction orthogonal to the width direction of the fixing member body 151. The curved outer shape of the bulging portion 159 has a curvature radius R of 5 mm (R5) or more and 100 mm (R100) or less, preferably 5 mm (R5) or more and 30 mm (R30) or less.

The fixing member 150 includes coolant discharge flow paths 172, a coolant introduction recessed part 173, and a coolant discharge recessed part 174. In this example, two coolant discharge flow paths 172 are formed. The coolant discharge flow paths 172 are disposed, for example, in parallel on the leading end side of the fixing member body 151 and formed along the front-rear direction, and are opened at the leading end of the fixing member body 151. The opening portions of the coolant discharge flow paths 172 is discharge ports 172a. Note that the two coolant discharge flow paths 172 are not limited to those arranged in parallel.

The coolant introduction recessed part 173 and the coolant discharge recessed part 174 communicate with each other. The coolant introduction recessed part 173 is formed at a lower end position of the through screw hole 152 of the fixing member body 151. The coolant discharge recessed part 174 is formed on the front side at the lower end of the through screw hole 152 of the fixing member body 151. The coolant discharge flow paths 172 communicate with the coolant discharge recessed part 174.

As illustrated in FIG. 18, the right-hand/left-hand double ended thread 160 has a first screw portion (screw portion) 161 on the leading end side and a second screw portion (screw portion) 162 on the rear end side. The first screw portion 161 and the second screw portion 162 are male screws of reverse threads. In the right-hand/left-hand double ended thread 160, the first screw portion 161 is screwed into the female screw 127 of the flow-path screw hole 121 of the tool body 10, and the second screw portion 162 is screwed into the through screw hole 152 of the fixing member 150.

### Fixation of Cutting Insert

Next, a case where the cutting insert 40 disposed in the insert mounting part 12 of the tool body 10 is fixed by the fixing member 150 will be described.

First, the engagement protrusions 153 of the fixing member 150 is inserted into the engagement holes 122 of the fixing member mounting part 16 with respect to the tool body 10 in which the cutting insert 40 is disposed in the insert mounting part 12. In addition, the first screw portion 161 of the right-hand/left-hand double ended thread 160 previously attached to the through screw hole 152 of the fixing member 150 is inserted into the female screw 127 of the flow-path screw hole 121 of the fixing member mounting part 16, and the fixing member body 151 is disposed on the upper portion of the fixing member mounting part 16. Then, the pressing protrusion 156 formed on the pressing portion 155 of the fixing member body 151 is fitted into the fixing hole 42 of the cutting insert 40.

In this state, the right-hand/left-hand double ended thread 160 is rotated, and the first screw portion 161 of the right-hand/left-hand double ended thread 160 is screwed into the female screw 127 of the flow-path screw hole 121 of the fixing member mounting part 16 of the tool body 10. Then, the right-hand/left-hand double ended thread 160 having the first screw portion 161 screwed into the female screw 127 moves to the inner part of female screw 127. Further, the fixing member 150 in which the second screw portion 162 of the right-hand/left-hand double ended thread 160 is screwed into the through screw hole 152 moves toward the tool body 10 which is the leading end side of the right-hand/left-hand double ended thread 160. As a result, the fixing member 150 is pulled toward the fixing member mounting part 16 of the tool body 10 by the right-hand/left-hand double ended thread 160 rotated in one rotation direction, and is pressed toward the fixing member mounting part 16. Then, by the pressing portion 155 of the fixing member 150, the cutting insert 40 is pressed against a shim 15 of the insert mounting part 12 of the tool body 10 by the pressing force F1.

Here, when the fixing member 150 is fastened to the tool body 10 by the right-hand/left-hand double ended thread 160, the bulging portion 159 having the outer shape curved in an arc shape in a cross-sectional view and formed along the width direction of the fixing member body 151 comes into contact with the upper end surface 43 of the cutting insert 40, and the cutting insert 40 is pressed and fixed by the bulging portion 159 (see FIG. 25). As a result, the cutting insert 40 is pressed and fixed in a stable state by the fixing member 150 without defects such as wear and deformation due to load concentration.

When the fixing member 150 is pressed against the fixing member mounting part 16, the sliding surface 158 of the fixing member body 151 comes into contact with the sliding surface 18 of the tool body 10 and slides. Then, the fixing member 150 is pulled rearward of the tool body 10 by the component force F3 of the reaction force F2 from the sliding surface 18 of the tool body 10. As a result, the pressing protrusion 156 fitted into the fixing hole 42 of the cutting insert 40 moves rearward while contacting the inner peripheral surface of the fixing hole 42. Therefore, the cutting insert 40 is pulled toward the rear side of the insert mounting part 12 of the tool body 10 by the pressing protrusion 156 of the fixing member 150 and is pressed against the side wall surface 14. As described above, the cutting tool 200 has a double clamp fixing system in which the fixing member 150 presses two positions of the upper end surface 43 of the cutting insert 40 and the inner peripheral surface of the fixing hole 42.

Here, the axes of the through screw hole 152 and the engagement protrusions 153 of the fixing member 150 are inclined downward to the side opposite to the pressing portion 155 with respect to the bottom surface of the fixing member body 151 having the pressing portion 155. Therefore, when the fixing member 150 is fixed to the tool body 10 by the right-hand/left-hand double ended thread 160, the fixing member 150 can be displaced rearward of the tool body 10 without difficulty and double-clamped.

In a clamped state where the cutting insert 40 is fixed to the insert mounting part 12, the two engagement protrusions 153 of the fixing member 150 are inserted into and engaged with the engagement holes 122 of the tool body 10. As a result, the fixing member 150 is prevented from rotating about the axis of the right-hand/left-hand double ended thread 160. Therefore, fluctuation of the fixing member 150 at the time of cutting by the cutting insert 40 of the cutting tool 200 is suppressed, and preferable cutting by the cutting insert 40 is achieved.

Further, in a clamped state where the cutting insert 40 is fixed to the insert mounting part 12, the recessed part 124 of the mounting surface 17 of the tool body 10 communicates with the coolant introduction recessed part 173 and the coolant discharge recessed part 174. The recessed part 124, the coolant introduction recessed part 173, and the coolant discharge recessed part 174 that communicate with one another form a coolant reservoir 175 having a larger flow passage cross section than the coolant introduction flow paths 123 and the coolant discharge flow paths 172 (see FIG. 18). The O-ring 126 attached to the mounting surface 17 of the tool body 10 is in close contact with the bottom surface of the fixing member body 151. This configuration seals the periphery of the communicating portion at the recessed part 124 between the bottom portion of the fixing member 150 and the mounting surface 17 of the fixing member mounting part 16, and the communicating portion between the coolant introduction recessed part 173 and the coolant discharge recessed part 174.

In the clamped state of the cutting insert 40, the coolant fed from the coolant main flow path 31 to the coolant introduction flow paths 123 via the coolant branch flow path 32 is fed to the coolant discharge flow paths 172 via the coolant reservoir 175 including the recessed part 124, the coolant introduction recessed part 173, and the coolant discharge recessed part 174 communicating with each other, and is discharged from the discharge ports 172a at the leading end of the fixing member 150. As a result, the coolant discharged from the discharge ports 172a at the leading end of the fixing member 150 is blown to the cutting place by the cutting insert 40 together with the coolant discharged from the discharge ports 34a at the leading end of the tool body 10. As a result, the cutting place by the cutting insert 40 is favorably cooled and lubricated. Here, the coolant reservoir 175 having a large flow path cross section is provided between the coolant introduction flow paths 123 and the coolant discharge flow paths 172. Therefore, the pressure loss of the coolant when the coolant is fed from the coolant introduction flow paths 123 to the coolant discharge flow paths 172 having a small inner diameter can be suppressed, and the coolant can be satisfactorily discharged from the discharge ports 172a.

### Removal of Cutting Insert

Next, a case of removing the cutting insert 40 fixed to the insert mounting part 12 of the tool body 10 by the fixing member 150 will be described.

In order to remove the cutting insert 40, the right-hand/left-hand double ended thread 160 fixing the fixing member 150 is rotated in the other rotational direction opposite to the direction at the time of fixing. Then, the first screw portion 161 of the right-hand/left-hand double ended thread 160 is removed from the female screw 127 of the flow-path screw hole 121 of the tool body 10. Further, the fixing member 150 in which the second screw portion 162 of the right-hand/left-hand double ended thread 160 is screwed into the through screw hole 152 moves to the side opposite to the tool body 10 which is the rear end side of the right-hand/left-hand double ended thread 160. As a result, the fixing member 150 is pushed up in a direction away from the fixing member mounting part 16 of the tool body 10 by the right-hand/left-hand double ended thread 160 that is rotated in the other rotation direction. As a result, the fixation of the cutting insert 40 by the fixing member 150 is released.

Further, when the fixing member 150 is pushed up by the right-hand/left-hand double ended thread 160, the engagement protrusions 153 are pulled out from the engagement holes 122. Here, the axes of the through screw hole 152 and the engagement protrusions 153 of the fixing member 150 are inclined downward to the side opposite to the pressing portion 155 with respect to the bottom surface of the fixing member body 151 having the pressing portion 155. Therefore, when the fixing member 150 is detached from the tool body 10 by the right-hand/left-hand double ended thread 160, the rear portion of the fixing member 150 can be smoothly separated from the tool body 10. The first screw portion 161 of the right-hand/left-hand double ended thread 160 is pulled out from the flow-path screw hole 121 of the tool body 10, so that the fixing member 150 whose rear portion is pushed up can be easily gripped and removed.

As described above, according to the fixing member 150 of the second embodiment, by being fastened to the tool body 10 by the right-hand/left-hand double ended thread 160, the cutting insert 40 is pressed and fixed by the bulging portion 159 having an outer shape curved in an arc shape in a cross-sectional view and formed along the width direction of the fixing member body 151. As a result, as compared with a case where the cutting insert 40 is pressed by a smooth surface or a plurality of spherical protrusions, the cutting insert 40 can be pressed and fixed in a stable state without defects such as wear and deformation due to concentration of load, and good cutting processing by the cutting insert 40 can be performed.

In particular, by setting the curvature radius R of the arcuately curved outer shape of the bulging portion 159 to 5 mm or more and 30 mm or less, it is possible to press the cutting insert 40 in a stable state while further suppressing concentration of a load.

According to the above embodiment, the two engagement protrusions 153 of the fixing member 150 are engaged with the engagement holes 122 of the tool body 10, but one engagement protrusion 153 may be provided to the fixing member 150, and the engagement protrusion 153 may be engaged with an engagement hole 122 of the tool body 10. In this case, the fixing member 150 can also be satisfactorily prevented from rotating with respect to the tool body 10.

What is claimed is:

1. A fixing member pressing and fixing a cutting insert disposed on an insert mounting part of a tool body, the fixing member comprising:
a fixing member body configured to be fastened to a fixing member mounting part of the tool body; and
a pressing portion that is provided to the fixing member body and configured to press the cutting insert when the fixing member body is fastened to the tool body, wherein
in the pressing portion, a bulging portion having an outer shape, in which a cross-sectional view in a direction orthogonal to a width direction of the fixing member body is curved in an arc shape, is formed along the width direction of the fixing member body.

2. The fixing member according to claim 1, wherein
a curvature radius of the outer shape of the bulging portion curved in an arc shape is 5 mm or more and 100 mm or less.

3. The fixing member according to claim 1, wherein
a curvature radius of the outer shape of the bulging portion curved in an arc shape is 5 mm or more and 30 mm or less.

4. The fixing member according to claim 1, wherein
the bulging portion is formed in parallel with the width direction of the fixing member body.

5. The fixing member according to claim 1, further comprising:
a fitting protrusion protruding from a bottom portion of the fixing member body and configured to be fitted into a fitting hole formed in the tool body; and
an engagement recessed part formed on a peripheral surface of the fitting protrusion and configured to be engaged with a leading end of a fastening member that is screwed into a screw hole communicating with the fitting hole of the tool body, wherein
the pressing portion presses and fixes the cutting insert, with the fitting protrusion being pulled into the fitting hole by the fastening member engaged with the engagement recessed part.

6. The fixing member according to claim 1, further comprising
a through screw hole formed in the fixing member body, wherein
a right-hand/left-hand double ended thread has screw portions having reverse threads in one end side and an other end side respectively, the screw portion on the one end side being screwed into a female screw of the tool body, the screw portion on the other end side being screw-engaged with the through screw hole, and
the tool body and the fixing member body are pulled toward each other by rotation of the right-hand/left-hand double ended thread in one rotation direction, and the tool body and the fixing member body are pulled away from each other by rotation of the right-hand/left-hand double ended thread in another rotation direction.

7. A cutting tool comprising:
a tool body including the fixing member according to claim 1 and having an insert mounting part to which a cutting insert is disposed and a fixing member mounting part to which the fixing member is assembled, and
the cutting insert disposed on the insert mounting part and pressed and fixed by the fixing member.
